(19) United States
(12) Patent Application Publication
(10) Pub. No.: US 2012/0280579 A1
(43) Pub. Date: Nov. 8, 2012

(54) LINEAR MOVING MAGNET MOTOR COGGING FORCE RIPPLE REDUCING

(75) Inventors: Richard Tucker Carlmark, Cumberland, RI (US); Mark A. Hayner, Belmont, MA (US); Stephen J. Maguire, Grafton, MA (US)

(73) Assignee: BOSE CORPORATION, Framingham, MA (US)

(21) Appl. No.: 13/196,128

(22) Filed: Aug. 2, 2011

Related U.S. Application Data
(60) Provisional application No. 61/483,179, filed on May 6, 2011.

(51) Int. Cl. H02K 41/02

(52) U.S. Cl. 310/12.24

(57) ABSTRACT

A magnet structure for a linear motor. Magnet tiles of the magnet structure are arranged so that intra-pole tile gaps extend in a direction parallel to the direction of motion of the linear motor.

### RELATIONSHIP TO RELATED APPLICATIONS

This application claims priority to U.S. Provisional Patent App. 61/483,179, incorporated by reference in its entirety.

### BACKGROUND

This specification describes a magnet tile structure for an armature of a linear motor.

### SUMMARY

In one aspect an armature for a linear motor includes a magnet structure having a pole section. The pole section includes magnet tiles separated by linear intra-pole gaps filled with non-magnetic, non-electrically-conductive material. The gaps extend in a direction parallel to the intended direction of motion. The magnet structure may have more than one pole sections. Each pole section may include magnet tiles separated by linear intra-pole gaps filled with non-magnetic, non-electrically-conductive material. The gaps may extend in a direction parallel to the intended direction of motion. The armature of claim may further include a frame structure that engages at least some of the magnet tiles at less than two edges. The frame may not engage any edge of at least some of the magnet tiles. A plurality of the magnet tiles may have two edges that may be substantially shorter than two other edges. The magnet structure may be dimensioned and configured so that no intra-pole gap aligns with a stator tooth edge at any point of the travel of the armature.

In another aspect, an armature for a linear motor includes a magnet structure having a pole section. Each pole section includes elongated magnet tiles separated by intra-pole gaps filled with non-magnetic, non-electrically-conductive material. The direction of elongation may be parallel to the intended direction of motion. The magnet structure may have more than two pole sections. Each pole section may include elongated magnet tiles separated by intra-pole gaps filled with non-magnetic, non-electrically-conductive material. The direction of elongation may be parallel to the intended direction of motion. The armature may further include a frame structure that engages at least some of the magnet tiles at less than two edges. The frame may not engage any edge of at least some of the magnet tiles. The armature may further include a frame that comprises a lateral strut perpendicular to the intended direction of motion and intermediate the ends of the frame and engaging a shorter edge of at least two of the tiles. The magnet structure may be dimensioned and configured so that no intra-pole gap aligns with a stator tooth edge at any point of the travel of the armature.

In another aspect, a linear motor includes a first core of includes material made of low magnetic reluctance. The first core has edges. The linear motor also includes a second core of includes material made of low magnetic reluctance. The second core has edge. The linear motor includes an armature that includes a magnet structure. The magnet structure includes magnet tiles separated by gaps filled with non-magnetic, non-electrically conductive material. The first core, the second core, and the armature are dimensioned and arranged so that when an edge of the first core is aligned with a gap, the edges of the second core is not aligned with a gap.

Other features, objects, and advantages will become apparent from the following detailed description, when read in connection with the following drawing, in which:

### BRIEF DESCRIPTION OF THE SEVERAL VIEWS OF THE DRAWING

FIG. 1 is a simplified isometric view of a moving magnet linear motor;

FIG. 2A and 2B is a simplified view of a magnet carrier;

FIG. 2B is a simplified view of a magnet carrier and magnet structure;

FIG. 3 is a diagrammatic view of a tiled magnet structure;

FIG. 4 is a diagrammatic view of a stator tooth and magnet tiles;

FIG. 5 is a plot of force vs. displacement of a linear motor;

FIG. 6 is a diagrammatic view of a magnet carrier and magnet structure;

FIG. 7 is a drawing of a magnet structure; and

FIG. 8 is a diagrammatic view of a stator teeth and magnet tiles.

### DETAILED DESCRIPTION

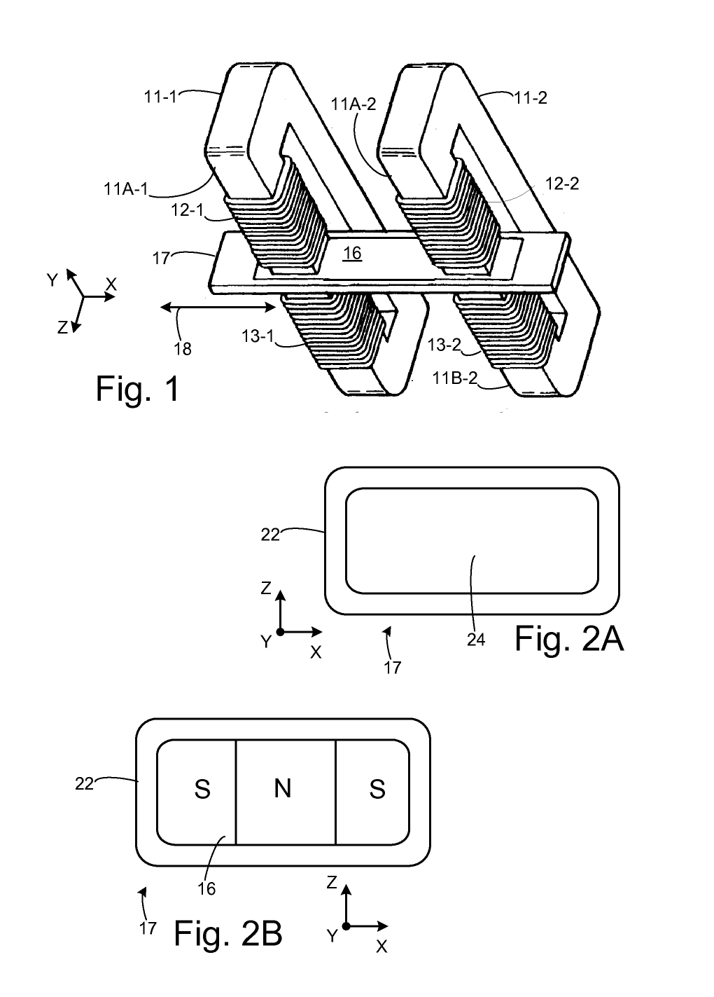

FIG. 1 shows a simplified isometric view of a moving magnet linear motor (also referred to as a linear actuator) and a coordinate system that will be used in subsequent figures. A first winding 12-1 and a second winding 13-1 are wound around legs 11A-1 and 11B-1 of a C-shaped core 11-1 of material of low magnetic reluctance, such as soft iron. A first winding 12-2 and a second winding 13-2 are wound around legs 11A-2 and 11B-2 of a second C-shaped core 11-2 of material of low magnetic reluctance, such as soft iron. Permanent magnet 16 seated in movable magnet carrier 17 is positioned in an air gap in the C-shaped cores, preferably filling a much of the air gap as possible, without contacting the C-shaped cores. Permanent magnet 16 has adjacent unlike poles (not shown in this view) between opposed surfaces of cores 11-1 and 11-2. The movable magnet carrier 17 and the permanent magnet 16 are components of the armature of the linear motor; other components of the armature are not shown in this figure. The movable magnet carrier is supported by a suspension, not shown, that permits motion in the X-direction indicated by arrow 18 while opposing lateral (that is, Y-direction according to the coordinate system of FIG. 1) “crashing” forces that urge the magnets toward the opposing faces of the C-shaped cores. In this and subsequent figures, the X-direction will be the intended direction of motion of the armature, the Y-direction will be the crashing force direction perpendicular to the plane of the armature, and the Z-direction will be in the plane of the armature, perpendicular to the intended direction of motion. In the figures, the intended direction of motion (the X-direction) is vertical.

In operation, an alternating current signal, for example a motion control signal, in the windings 12-1, 13-1, 12-2 and 13-2 interacts with the magnetic field of the permanent magnet 16, which causes motion of the armature in the direction indicated by arrow 18.

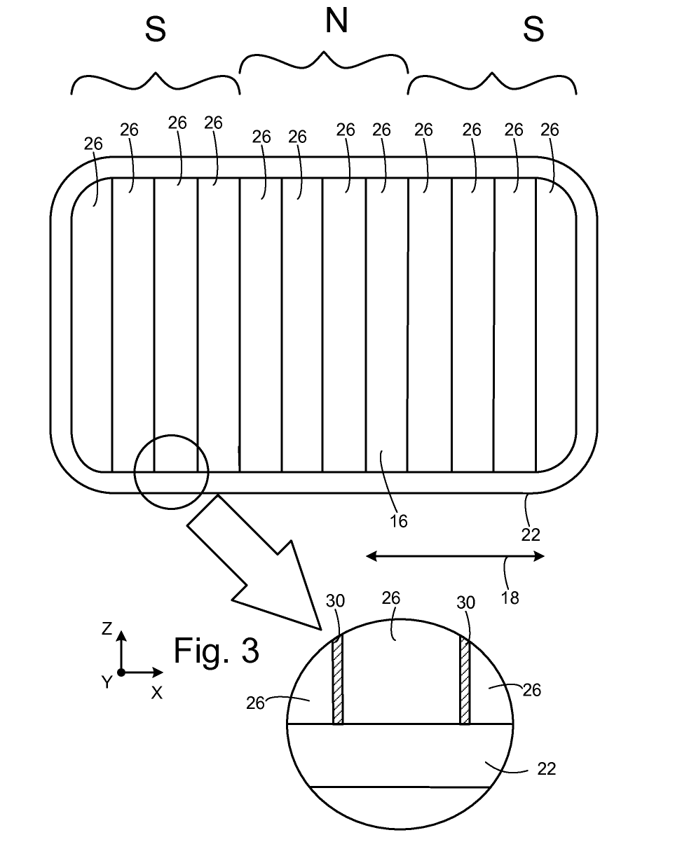

FIG. 2A shows a simplified view of the magnet carrier 17. A typical configuration for a magnet carrier is a frame 22 and window 24 configuration.

As shown in FIG. 2B, the frame 22 engages the magnet 16 on all four sides of the magnet. The magnet may be held in place mechanically by an adhesive, such as an epoxy, or by an interference fit with or without adhesive to supplement the interference fit. The magnet carrier may have structure (not shown) to couple the armature to surrounding structure so that the mechanical energy (motion and force) generated by operation of the linear motor can be usefully employed.

The magnet has one or more pole sections. In the example of FIG. 2B, the magnet has two south pole sections (designated “S”) and one north pole section (designated “N”). Other implementations may have fewer poles or more poles.

In some implementations, the north pole sections and south poles sections may be monolithic structures. However, especially as the magnets get larger, a monolithic pole section may be undesirable. Monolithic poles structures may facilitate eddy currents which lead to undesirable heating loss in the magnet.

The undesirable heating loss in a monolithic magnet pole is proportional to the derivative with respect to time of the coil flux striking normal to the XZ plane of a monolithic magnet pole. Subdividing the monolithic magnet pole into smaller electrically isolated subsections results in less undesirable heating loss than would otherwise occur in the undivided monolithic pole.

Additionally, large monolithic pole structures may be difficult to magnetize using conventional magnetizing coils and there are practical limits to the size of a single block of magnet material that can be easily manufactured.

To avoid the problem of power dissipation due to eddy currents and the difficulty of manufacturing and magnetizing monolithic pole structures, the pole structures may be composed of individual “tiles” 26, as shown in FIG. 3, so that the pole structures are broken up in the plane in which the coil flux is perpendicular to the magnet, in this embodiment, the x-z plane. The magnet 16 of FIG. 3 includes two south poles structures and a north pole structure. Each of the pole structures includes four individual “tiles” 26. In an actual implementation, each tile structure may include more than four, for example nine, tiles. Each of the tiles are elongated rectangles in this view, with the direction of elongation oriented perpendicular to the direction of motion, indicated by arrow 18. Each of the tiles are engaged by the frame 22 on at least two edges. A non-conductive, non-magnetic, adhesive, for example an epoxy is placed in the gap, for example gap 30, between adjacent tiles. The structure of FIG. 3 permits the use of reasonable sizes of magnetic material and the use of conventionally sized magnetizing coils. Undesirable eddy current losses have be reduced through the use of more and smaller tiles. They therefore do not dissipate much power and do not generate as much heat as structures that are subject to eddy currents of longer path length associated with fewer, larger tiles.

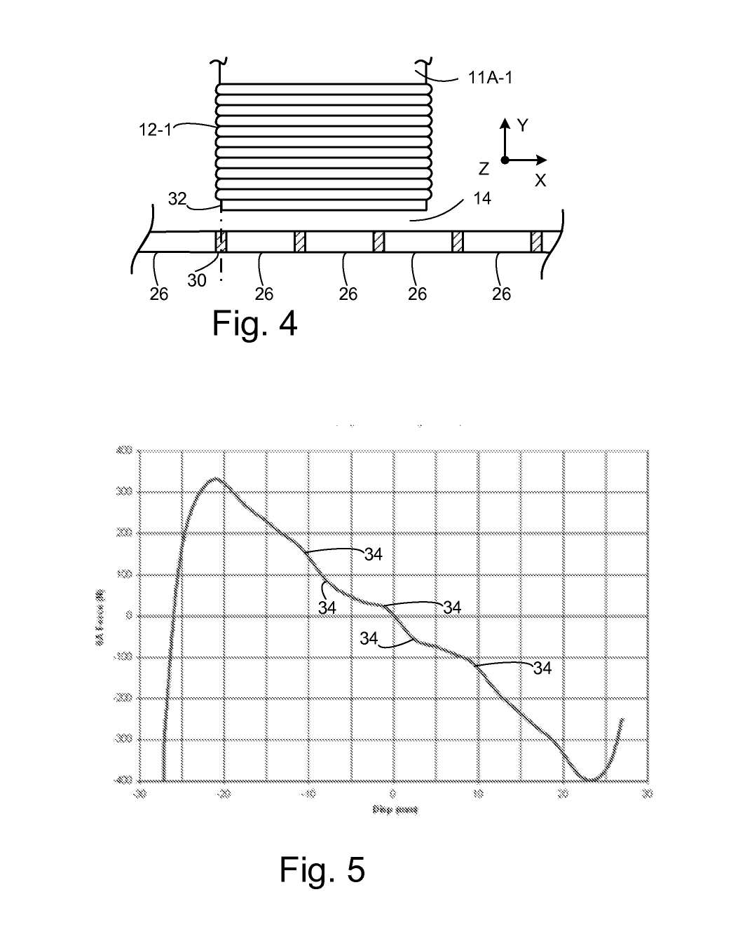

Unfortunately, as shown in FIG. 4, the structure of FIG. 3 is subject to cogging forces when the edge 32 of the core (hereinafter the “stator tooth”) is aligned with a gap 30 between adjacent tiles of a pole (hereinafter intra-pole gaps). The cogging forces cause irregularities and/or non-linearities 34 (sometimes referred to as cogging force ripple) in the force vs. displacement curve of FIG. 5. Cogging force ripple may cause difficulty in controlling the motion of the armature of the linear motor.

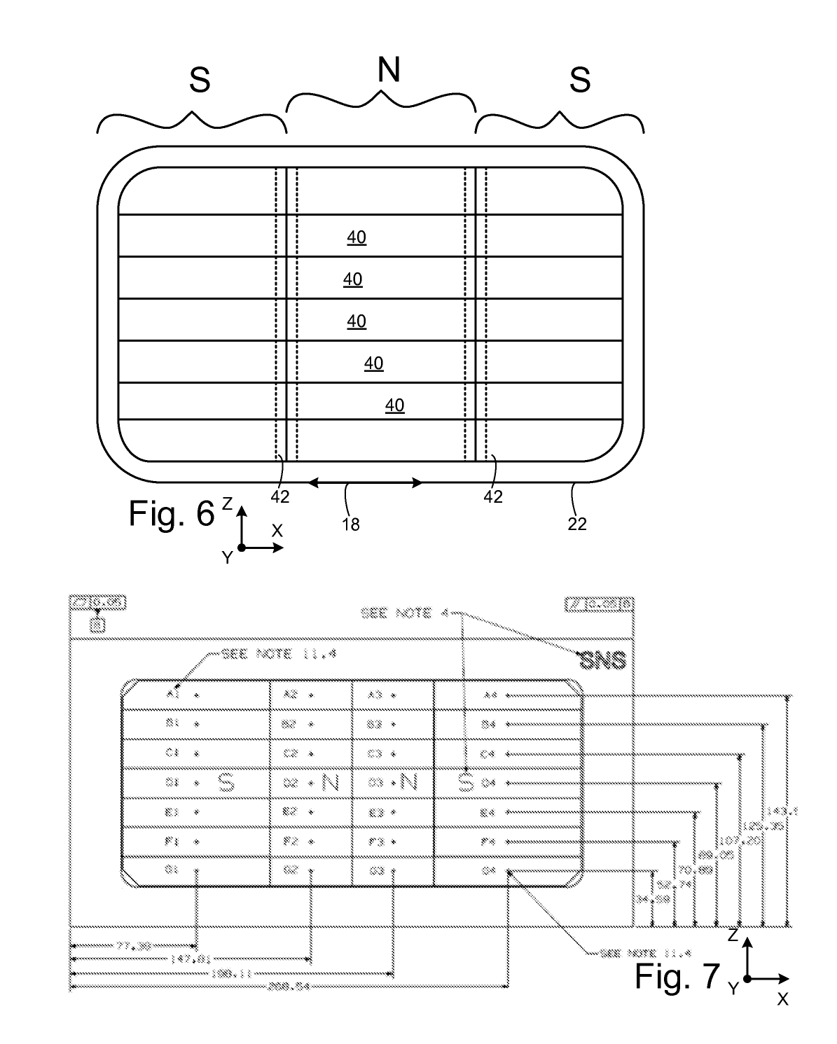

FIG. 6 shows a structure that reduces cogging force ripple. In the structure of FIG. 6, the tiles are elongated rectangles in the view of FIG. 6, with the direction of elongation oriented parallel to the direction of motion (the x-direction), indicated by arrow 18. With the structure of FIG. 6, the edges of the stator teeth do not align with any intra-pole gaps, so cogging forces resulting from alignment of stator teeth with intra-pole gaps are substantially eliminated.

FIG. 7 shows an actual implementation of the structure of FIG. 6, with dimensions (in mm) shown. In the implementation of FIG. 7, the north pole section includes two tiles, for example 48 and 50, arranged lengthwise, with a resultant intra-pole gap 52, in the direction of direction of motion of the armature. However, this intra-pole gap 52 does not need to cause cogging force ripple because the configuration, stroke, and dimensions of the components of the linear motor can be arranged so that the intra-pole gap 52 does not line up with an edge of a stator tooth during operation of the motor.

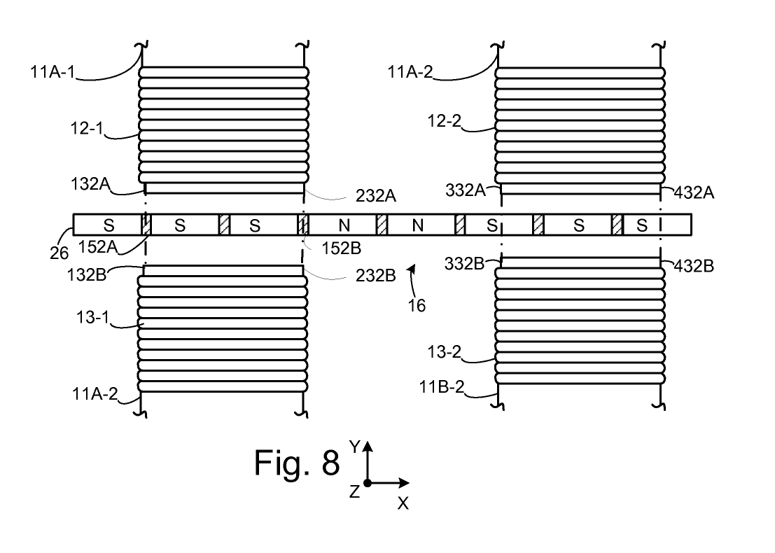

FIG. 8 illustrates another structure for reducing cogging forces. In the structure of FIG. 8, the tiles are arranged as in FIG. 3. The dimensions and placement of the stator teeth and the dimensions and configuration of the tiles 24 are arranged so that when the edge of a stator tooth such as edges 132A, 132B, 232A and 232B of are aligned with intra-pole gaps 152A and 152B, the edges of another stator tooth, such as edges 332A, 332B, 432A, and 432B are not aligned with an intra-pole gap.

Numerous uses of and departures from the specific apparatus and techniques disclosed herein may be made without departing from the inventive concepts. Consequently, the invention is to be construed as embracing each and every novel feature and novel combination of features disclosed herein and limited only by the spirit and scope of the appended claims.

What is claimed is:

1. An armature for a linear motor, comprising:
a magnet structure having a pole section, the pole section comprising magnet tiles separated by linear intra-pole gaps filled with non-magnetic, non-electrically-conductive material, wherein the gaps extend in a direction parallel to the intended direction of motion.

2. The armature of claim 1, wherein the magnet structure has more than one pole sections, each pole section comprising magnet tiles separated by linear intra-pole gaps filled with non-magnetic, non-electrically-conductive material, wherein the gaps extend in a direction parallel to the intended direction of motion.

3. The armature of claim 1, further comprising a frame structure that engages at least some of the magnet tiles at less than two edges.

4. The armature of claim 3, wherein the frame does not engage any edge of at least some of the magnet tiles.

5. The armature of claim 1, wherein a plurality of the magnet tiles have two edges that are substantially shorter than two other edges.

6. The armature of claim 1, wherein the magnet structure is dimensioned and configured so that no intra-pole gap aligns with a stator tooth edge at any point of the travel of the armature.

7. An armature for a linear motor, comprising:
a magnet structure having a pole section, each pole section comprising elongated magnet tiles separated by intra-pole gaps filled with non-magnetic, non-electrically-conductive material, wherein the direction of elongation is parallel to the intended direction of motion.

8. The armature of claim 7, wherein the magnet structure has more than two pole sections, each pole section comprising elongated magnet tiles separated by intra-pole gaps filled with non-magnetic, non-electrically-conductive material, wherein the direction of elongation is parallel to the intended direction of motion.

9. The armature of claim 7, further comprising a frame structure that engages at least some of the magnet tiles at less than two edges.

10. The armature of claim 9, wherein the frame does not engage any edge of at least some of the magnet tiles.

11. The armature of claim 7, the armature further comprising a frame that comprises a lateral strut perpendicular to the intended direction of motion and intermediate the ends of the frame and engaging a shorter edge of at least two of the tiles.

12. The armature of claim 7, wherein the magnet structure is dimensioned and configured so that no intra-pole gap aligns with a stator tooth edge at any point of the travel of the armature.

13. A linear motor comprising:
a first core of comprising material made of low magnetic reluctance, the first core having edges;
a second core of comprising material made of low magnetic reluctance, the second core having edges;
an armature comprising a magnet structure, the magnet structure comprising magnet tiles separated by gaps filled with non-magnetic, non-electrically conductive material,
wherein the first core, the second core, and the armature are dimensioned and arranged so that when an edge of the first core is aligned with a gap, the edges of the second core are not aligned with a gap.
